(19) United States
(12) Patent Application Publication
(10) Pub. No.: US 2004/0113055 A1
(43) Pub. Date: Jun. 17, 2004

(54) Sensors system and method incorporating fibre bragg gratings

(76) Inventors: Maurice Patrick Whelan, Angera/Va (IT); Robert Kenny, Riance (IT)

Correspondence Address: NATH & ASSOCIATES, 1030 15th STREET, 6TH FLOOR, WASHINGTON, DC, 20005, US

(21) Appl. No.: 10/474,551

(22) PCT Filed: May 8, 2002
(86) PCT No.: PCT/EP02/05116

(30) Foreign Application Priority Data
May 9, 2001 (GB) 0111295.2

(51) Int. Cl. G01J 4/00

(52) U.S. Cl. 250/227.18

(57) ABSTRACT

A sensor system comprises first and second fibre bragg gratings (FBGs). The two fibre bragg gratings receive light from a common light source and produce respective measurement signals having a spectrum dependent on a measurement signals having a spectrum dependent on a measurand, and a common reference signal. The two measurement signals pass through respective edge filters to respective detectors and a third detector monitors the reference intensity. A processor produces a value for the measurand from the received and detected signals. The system can be used in a temperature compensated strain gauge.

The present invention relates to sensor systems and methods using fibre Bragg gratings (FBGs) as sensors, and utilising edge filter techniques to interrogate those FBGs. In particular, although not exclusively, the present invention relates to multi-channel sensor systems providing temperature-compensated measurements of strain.

Fibre Bragg gratings (also known as in-fibre Bragg gratings) are well known, as is their use as sensors to detect/measure a variety of parameters. For example, it is known to use FBGs as strain sensors. If coupled to a panel whose strain is to be monitored, strain transmitted to the FBG will alter its period and average refractive index, and result in a change in its reflectance spectrum. This can be detected, and used as an indication of the strain experienced by the panel.

The review article “In-fibre Bragg grating sensors”, Y-J Rao, Meas. Sci. Technol. 8 (1997) 355-375, describes the structure and manufacture of FBGs, their properties, and a number of sensor systems, in which the FBG sensors are interrogated using a variety of techniques.

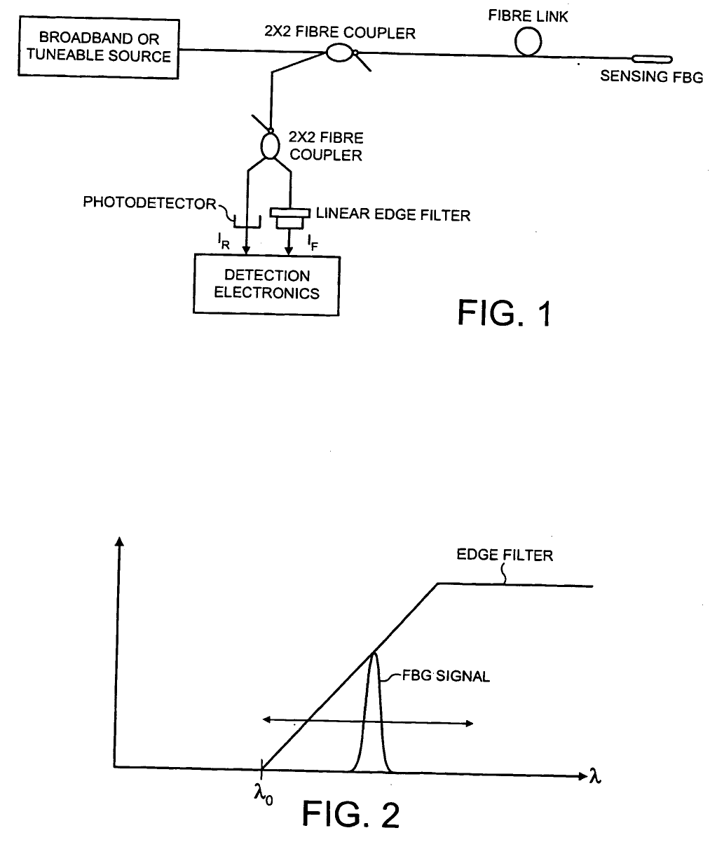

Rao discloses a sensor system based on the interrogation of a single FBG using an edge filter technique. A block diagram of the system disclosed by Rao is shown in FIG. 1. In order to eliminate the influences of intensity fluctuations of the light source and the fibre link, the ratio between the signal intensity I_{F} and the reference intensity I_{R} is used, is used given by

I_{F}/I_{R}=A (λ_{B}−λ₀+Δλ/√π)

Where A and λ₀ are the gradient and the starting value of the edge filter and λ_{B} and Δλ are the Bragg wavelength and the linewidth of the FBG respectively. The principle of the edge filter method of interrogation of the FBG is illustrated in FIG. 2. The method is based on the use of an edge filter which has an approximately linear relationship between wavelength shifts and the output intensity changes of the filter. By measuring the intensity change, the wavelength shift induced by the measurand is obtained. The measurement range is inversely proportional to the detection resolution.

The system disclosed by Rao has several advantages, such as low cost, fast response, ease of use, and all of the other usual advantages of using a passive fibre optic sensor element (the FBG). However, problems associated with the sensor system disclosed by Rao are that it includes only a single sensor element (FBG) and so can make only a single measurement (i.e. it can measure only a single quantity or parameter).

Furthermore, if the sensor is used to measure a quantity other than temperature, it will be influenced by temperature fluctuations. For example, if the sensor is used for a strain measurement, strain will alter the FBG period and average refractive index, but temperature fluctuations will also have a significant effect. Thermal expansion and contraction of the FBG will alter its pitch, and its reflectance characteristics will also be influenced by changes in its effective refractive index, as a result of the thermooptic effect. Thus, the system disclosed by Rao cannot provide temperature compensated strain measurements.

A further disadvantage is that two detectors are required to measure the characteristics of the single grating. In multi-channel measurement systems, use of the Rao sensor system necessitates the use of a large number of sensors and edge filters (which are expensive components) and so increases the cost and complexity of the apparatus.

The Rao article mentions that the multiplexing of FBG sensors in edge filter based interrogation schemes needs to be addressed (section 4.2.2). However, the article contains no further information on how this could be achieved, and also states that the edge filter method has low compatibility with wavelength division multiplexing (table 7 on page 372).

An object of the present invention is to provide a relatively simple and cost effective sensor system, and corresponding method, incorporating two FBG sensor elements interrogated by an edge filter technique (and hence able to provide two measurements).

An object of embodiments of the present invention is to provide a relatively simple and cost effective sensor system able to provide temperature compensated measurement of strain, using two fibre Bragg gratings interrogated using an edge filter technique.

An object of further embodiments is to provide a system for the temperature compensated measurement of strain, using two multiplexed FBGs interrogated by an edge filter technique. An object of yet further embodiments is to provide a multi-channel sensing system (and corresponding method) based on the edge filter interrogation of FBGs, each channel providing temperature compensated measurement of strain.

According to a first aspect of the present invention there is provided a sensor system as defined by claim 1.

This system provides numerous advantages, including the fact that the two sensors (the FBGs) are interrogated using only three detectors, compared with the Rao system which requires two detectors for a single sensor. This is achieved because the reference detector is arranged to detect a combined reference signal from the two FBGs.

It will be appreciated that in certain arrangements the first measurement signal and first reference signal will not represent the total light signal output from the first FBG. The first measurement signal is simply that portion of the output which reaches the first edge filter. Similarly the first reference signal is that portion of the output which reaches the reference detector. In certain preferred embodiments, these signals will reach the filters and detectors via couplers and possibly demultiplexing devices. Thus, the first measurement signal and first reference signal may represent only a minor portion of the total light output from the first FBG. The same comments apply equally to the second measurement and reference signals.

Preferably the first and second FBGs may have different Bragg wavelengths, and the system may further comprise a length of optical fibre which is arranged to convey the first and second measurement signals simultaneously (i.e. the signals are multiplexed) and a demultiplexer connected to the length of optical fibre arranged to separate the first and second measurement signals and direct them to the first and second edge filters respectively.

The first and second FBGs may be arranged in series, in which case the first and second measurement signals will naturally be multiplexed. Alternatively, the FBGs may be arranged in parallel, and a coupler may be used to multiplex their respective measurement signals onto a single fibre.

The first and second measurement signals may be signals reflected by the first and second FBGs. Alternatively, they may be transmitted signals. The transmitted signal from each will typically include a notch (corresponding to the portion of incident light reflected by the grating). If the notch is narrow compared with the bandwidth of the linear portion of the edge filter, then as the notch shifts in wavelength (as a result, for example, of strain being applied to the grating) then the detector detecting the filtered signal may not see much change in intensity. However, if the gratings and edge filters are arranged such that the notch width is a substantial fraction of the bandwidth of the linear portion of the edge filter, then appreciable changes in detected intensity may be achieved, and thus the transmitted signals may be used satisfactorily to track changes in the reflectance spectra of the gratings.

Preferably, the sensor system may comprise a plurality of measurement channels. Each channel comprises a respective pair of gratings and a respective light source. The first and second edge filters are used as common edge filters to filter the first and second measurement signals from all of the channels. Similarly, the reference detector is used as a common reference detector, receiving the combined reference signals from each channel. The system further comprises a controller arranged to operate the light sources in any desired sequence. Thus, the sensors of each channel can be “polled”, and the same three detectors used to measure the properties of all of the gratings.

According to a second aspect of the present invention there is provided a sensor system comprising: a first fibre Bragg grating having a first nominal Bragg wavelength; a second fibre Bragg grating, arranged in series with the first, and having a second nominal Bragg wavelength; a light source arranged to provide light to the series combination of first and second fibre Bragg gratings for reflection; a reference detector arranged to detect an intensity of a reference signal comprising a first portion of the light reflected by the series combination of first and second fibre Bragg gratings; a demultiplexer arranged to receive a second portion of the light reflected by the series combination of first and second fibre Bragg gratings and to split the second portion into a first signal, comprising light reflected by the first fibre Bragg grating, and a second signal, comprising light reflected by the second fibre Bragg grating; a first edge filter arranged to filter the first signal; a first detector arranged to detect the intensity of the filtered first signal; a second edge filter arranged to filter the second signal; a second detector arranged to detect the intensity of the filtered second signal; and a processor arranged to process signals from the first, second and reference detectors.

This system provides numerous advantages, including the fact that two sensors (the FBGs) are interrogated using only three detectors, compared with the Rao system which requires two detectors for a single sensor.

Furthermore, the two FBG sensors are multiplexed on a single “channel”. The FBGs can in fact be formed/written on sequential portions of the same optical fibre. This arrangement provides the usual advantages associated with multiplexing. Also, by using two FBGs having different Bragg wavelengths, the process of demuliplexing the reflected signals from the series combination is made simple. A relatively inexpensive, simple demultiplexer can be used, which only needs to separate two signals according to wavelength.

Preferably, the processor may be arranged to determine the respective ratios of the intensities of the filtered first and second signals to the intensity of the reference signal.

By determining the intensity ratios, the processor can thus compensate for any fluctuations in the light source output power, and fluctuations in the losses associated with the optical fibre transmission paths connecting the source to the gratings, and the gratings back to the detectors and filters.

Preferably, the light source is coupled to the series combination of first and second fibre Bragg gratings by first and second couplers connected in series with each other, the second coupler being proximate the fibre Bragg gratings, the demultiplexer is coupled to the second coupler, and the reference detector is coupled to the first coupler, such that the second portion is received by the demultiplexer via the second coupler, and the reference signal reaches the reference detector via the second coupler and then the first coupler.

This arrangement provides the advantage that the intensities/powers of the signals reaching the reference detector and each edge filter are approximately matched. The power reaching the reference detector corresponds to the total power in the reflectance signal from the series combination of gratings, divided first by the second coupler, and then by the first coupler. The power reaching each edge filter corresponds to the total reflected signal power, divided first by the second coupler, and then by the demultiplexer.

In this preferred arrangement, the first and second couplers also are used to route the light from the light source to the series combination of gratings.

In alternative embodiments, the light from the source to the gratings, and the reflected signals from the gratings to the detectors can be routed separately.

Using the same two couplers to route the light supply and reflected signals provides the advantage of reduced system inventory.

Preferably, the sensor system further comprises a reflection suppressing termination, for example arranged in series after the FBGs, to suppress reflection of light transmitted by the FBGs back to the detectors.

Preferably the demultiplexer comprises a filter arranged to reflect light reflected by one of the first and second FBGs and to transmit light reflected by the other FBG. This provides a simple, convenient way of splitting the signals from the two gratings.

Advantageously, the demultiplexer may be a GRIN (gradient index) lens.

Preferably, the sensor system comprises a plurality of sensor channels, each sensor channel comprising a series combination of respective first and second FBGs, a respective light source, and a respective multiplexer. The system may further comprise a controller arranged to control the light sources so as to selectively illuminate the series combinations of FBGs of the different channels. In these arrangements, the reference detector, edge filters and first and second detectors are arranged as common elements to receive the appropriate reflected signals from all channels. By controlling the light sources, and ensuring that only one is “on” at any time, the common filters and detectors can be used to interrogate the FBG sensors of each channel independently.

Such systems provide all of the usual advantages associated with a multi-channel system. For example, they are able to measure a large number of quantities/parameters, and can be used to provide a degree of redundancy in a measurement system, able to continue to provide useful measurements when certain system components may fail.

Also, although the system is a multi-channel system, only three detectors and two edge filters are required. This represents a very much reduced system inventory, especially when compared with the prior art systems. requiring two detectors and one edge filter for each FBG.

Using a separate light source for each sensor channel, in addition to enabling the serial “polling” of the sensor channels, provides the further advantage that if one source fails, the other channels may continue to be used for measurement purposes. Furthermore, low power sources can be used, and by operating only one of the sources at any given time, the total power consumption of the system can be kept low.

According to a third aspect of the present invention there is provided a first fibre Bragg grating; a second fibre Bragg grating, arranged in parallel with the first; a light source arranged to provide light to the parallel combination of first and second fibre Bragg gratings for reflection; a reference detector arranged to detect an intensity of a reference signal comprising at least a portion of the light reflected by the parallel combination of first and second fibre Bragg gratings; a first edge filter arranged to filter a first signal comprising light transmitted by the first fibre Bragg grating; a first detector arranged to detect the intensity of the filtered first signal; a second edge filter arranged to filter a second signal comprising light transmitted by the second fibre Bragg grating; a second detector arrange to detect the intensity of the filtered second signal; and a processor arranged to process signals from the first, second and reference detectors. The two FBGs may have different, or the same Bragg wavelengths.

As with the first and second aspects of the invention, this third aspect provides the advantage that the two FBG sensor elements are interrogated using only three detectors and two edge filters. This third aspect provides the further advantage that no demultiplexer is required.

Again, the processor may be arranged to determine the respective ratios of the intensities of the filtered first and second signals to the intensity of the reference signal. In both the first and second aspects of the invention the processor may be arranged to perform a number of operations involving the signals received from the detectors. These operations may include one or more of the following: averaging; determining ratios; comparison with Look-Up Tables (LUT operations); multiplication by calibration factors. These operations may be combined as required.

Preferably the light source and reference detector are coupled to the first and second FBGs by a single, common coupler. This reduces the system inventory, and maximises the strength of the reflected signal returned to the reference detector.

Preferably, the transmitted signals from the first and second FBGs are conveyed to the first and second edge filters by separate respective optical fibres.

As with the first and second aspects, the sensor system according to the third aspect of the present invention can be employed in a multi-channel sensor system, each sensor channel comprising a respective light source, and a respective parallel combination of first and second FBGs. A controller may be arranged to selectively power-up the light sources, and common edge filters and detectors may be used to receive the reflected and transmitted signals from all of the channels. Once again, such a multi-channel system provides the advantages that a large number of measurements may be made using the array of sensors, whilst requiring only three detectors and two edge filters.

A further aspect of the present invention provides strain measurement apparatus including a sensor system in accordance with the first, second or third aspects. In this strain measurement apparatus the first FBG is arranged as to be influenced by both an external strain and temperature fluctuations, whilst the second FBG is arranged to experience substantially the same temperature fluctuations but is decoupled from the external strain. The processor is arranged to use the signals from the three detectors to determine a temperature-compensated value of the strain experienced by the first FBG. By preferably using the intensity ratios, this measurement may also be compensated for fluctuations in source power and losses in the signal-conveying fibres.

The fibre Bragg gratings of the various aspects of the present invention may be embedded/incorporated in a body or structure. Such a body/structure is known as a smart structure. The second FBG may be arranged in a pocket or sleeve inside the structure, so that it is decoupled from any strain of the surrounding material. The sensors can also be surface mounted.

A preferred embodiment of strain measurement apparatus in accordance with an aspect of the present invention, comprises an opto-electronics unit including the processor and light source or sources, and a solar panel and/or battery for powering the opt-electronics unit. This embodiment is adapted for use in remote locations. Preferably, it comprises a multi-channel sensor system, with the channels being interrogated in sequence. This reduces the total power consumption of the apparatus to a level which can be met by the solar panel. Such an embodiment is particularly advantageous in that it can be used in locations where no electrical power supply is available or permitted.

Preferably, the strain-measurement apparatus further comprises a GSM modem to communicate measured strain values to a remote location. In alternative embodiments, other types of communication methods may of course be used.

According to a further aspect of the present invention, there is provided a measurement method comprising the steps of arranging a sensor system in accordance with the first, second or third aspects of the invention, arranging the first FBG to sense a parameter (such as strain) to be measured, arranging the second FBG in substantially the same thermal environment as the first FBG and in a manner such that the second FBG is substantially insensitive to the parameter, and determining a temperature compensated value of the parameter from the signals from the detectors.

The phrase “arranging the second FBG in substantially the same thermal environment as the first FBG” should be interpreted as meaning that the second FBG is arranged with respect to the first FBG such that it experiences substantially the same temperature fluctuations as the first FBG. In many instances, this will simply involve positioning the second FBG as close as possible to the first.

Embodiments of the present invention will now be described with reference to the accompanying drawings, of which:

FIG. 1 is a schematic diagram of a sensor system in accordance with the prior art;

FIG. 2 is a diagram illustrating the principle of the edge filter technique for interrogating FBGs;

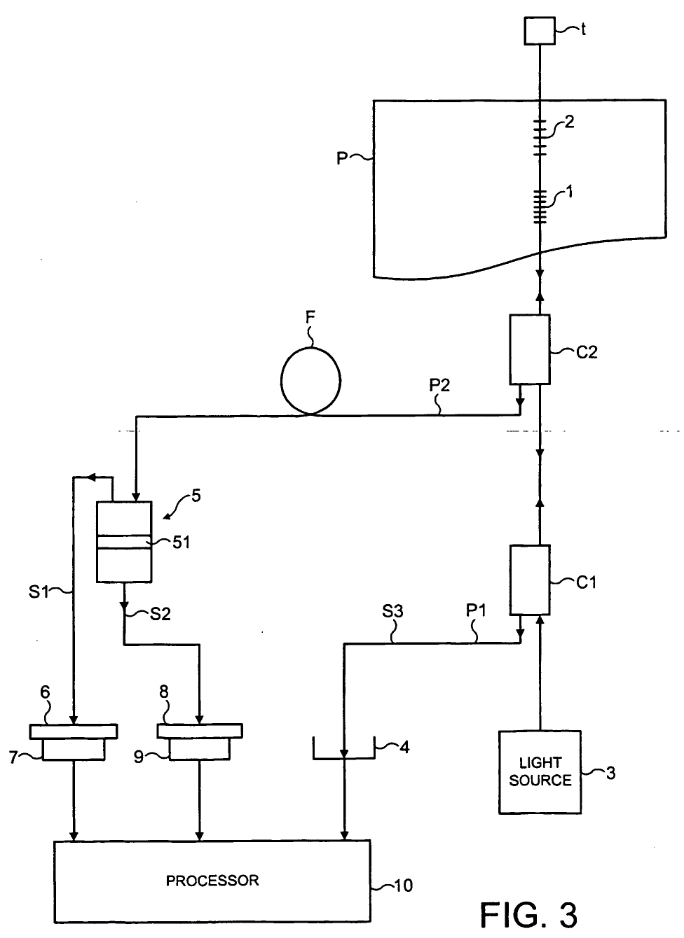

FIG. 3 is a schematic diagram of a sensor system in accordance with a first embodiment of the present invention;

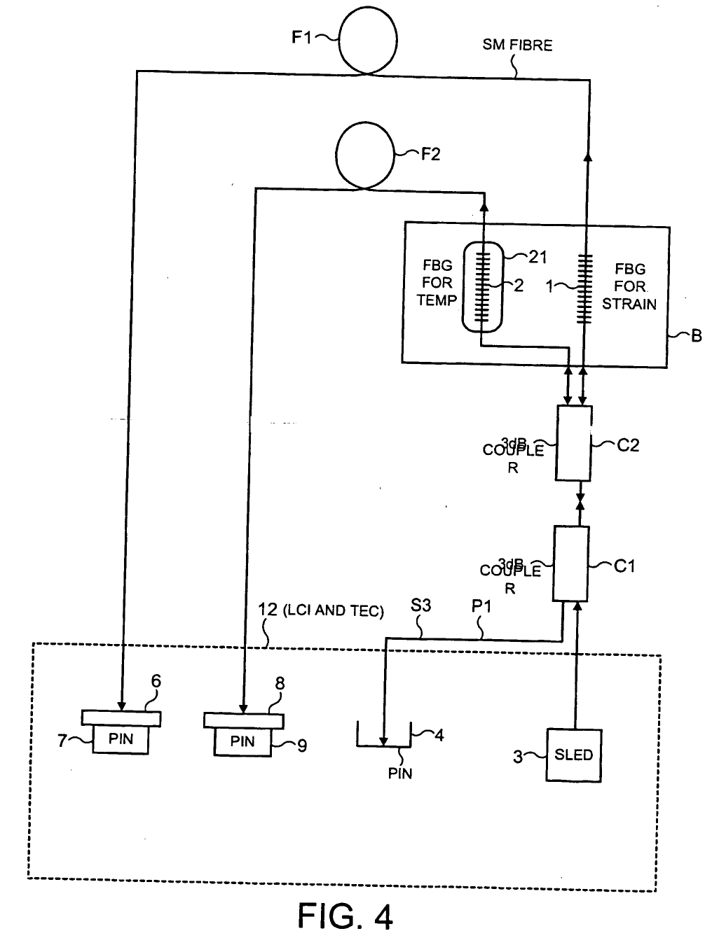

FIG. 4 is a schematic diagram of a sensor system in accordance with a second embodiment;

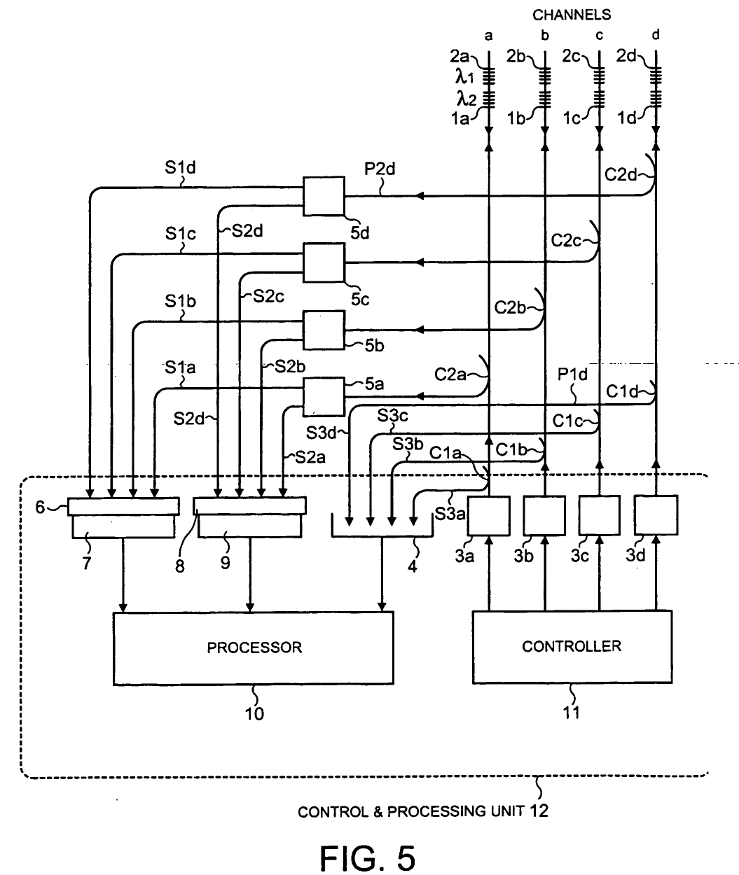

FIG. 5 is a schematic diagram of a multi-channel sensor system embodying the present invention;

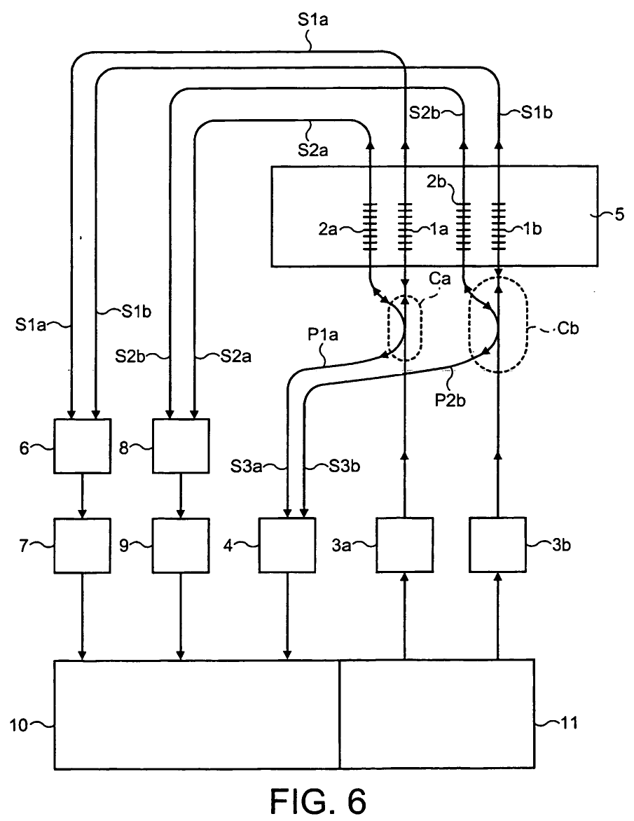

FIG. 6 is a schematic diagram of a further multi-channel sensor system embodying the present invention;

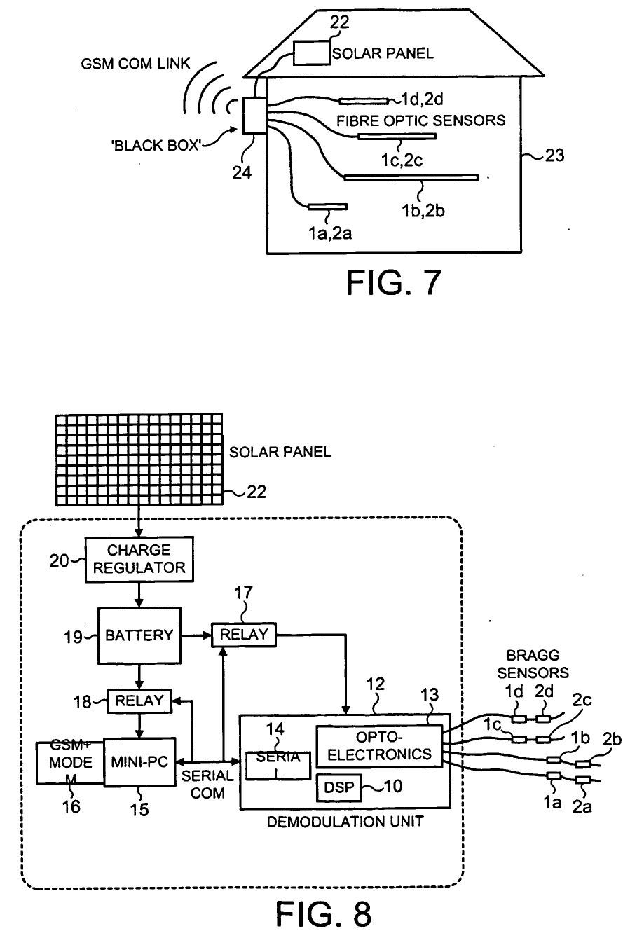

FIG. 7 is a schematic diagram of a fully integrated structural monitoring system embodying the present invention;

FIG. 8 is a schematic diagram of the components of the monitoring system shown in FIG. 7;

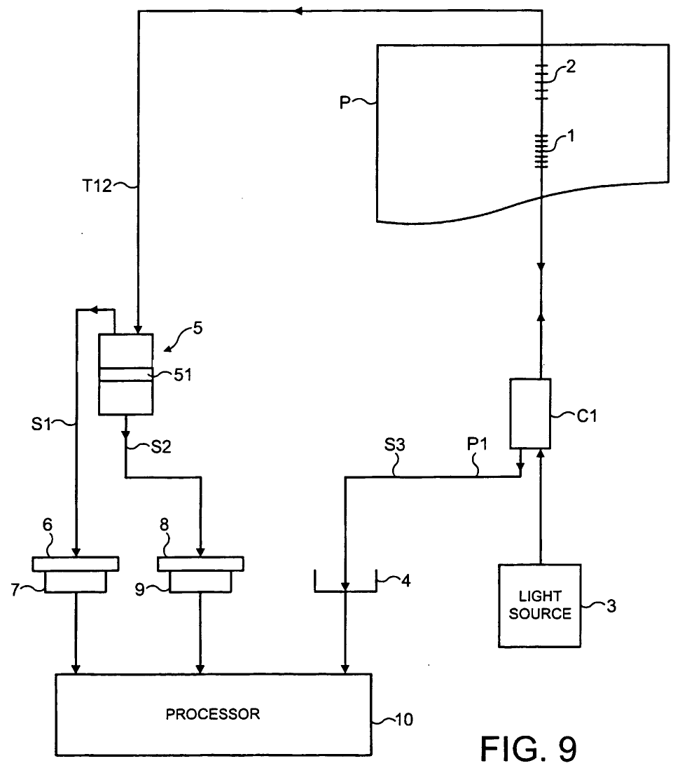

FIG. 9 is a schematic diagram of a further embodiment;

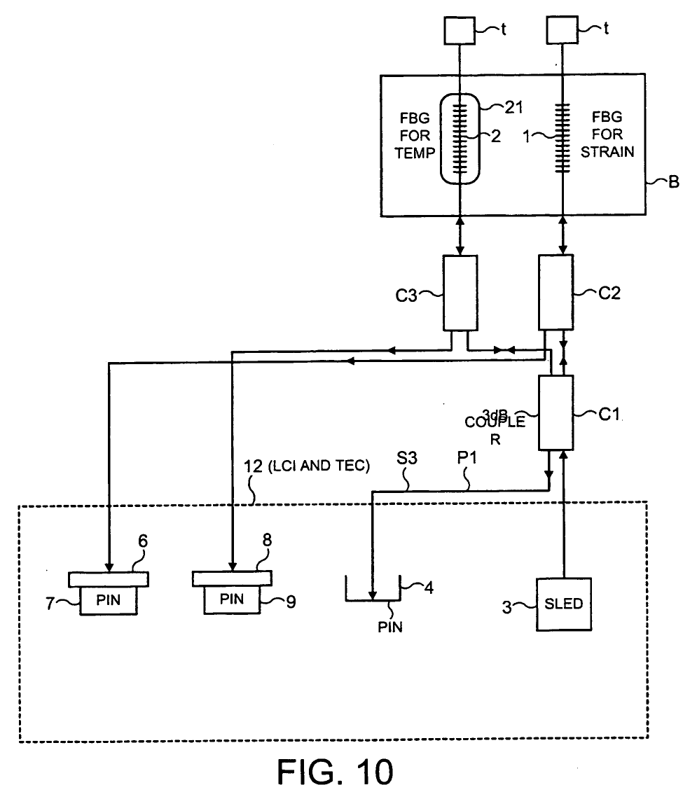

FIG. 10 is a schematic diagram of a further embodiment;

FIG. 11 is a schematic diagram of a further embodiment;

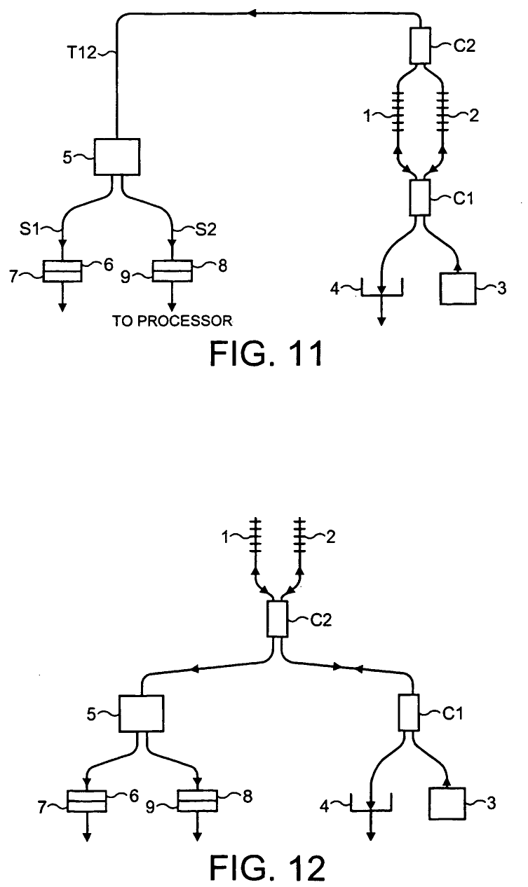

FIG. 12 is a schematic diagram of a further embodiment; and

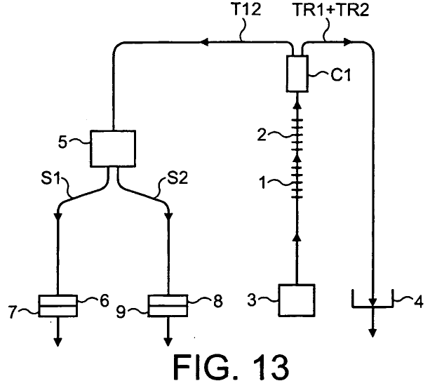

FIG. 13 is a schematic diagram of a further embodiment.

Referring now to FIG. 3, this shows a single channel sensor system embodying the present invention. The Figure shows a panel P under test, to which a first FBG1 has been bonded. A second FBG2 is arranged in close proximity to the first grating and in optical series with it. The two fibre Bragg gratings have different nominal Bragg wavelengths, in this example 1530 and 1570 nm respectively. The second FBG thus experiences substantially the same temperature and thermal fluctuations as the first FBG. However, the second FBG is not bonded to the panel P in the same way as the first grating. It is arranged so that strain of the panel P is not communicated to it, i.e. the pitch of the FBG2 is decoupled from strain of the panel P.

The series combination of first and second FBGs is illuminated by a light source 3, via a first bidirectional fibre optic coupler C1 and a second bidirectional fibre optic coupler C2. The light source 3 is selected so that its output spectrum encompasses the reflectance spectra of both of the gratings 1 and 2. In this example the two FBGs are formed on portions of the same optical fibre, which is terminated by a reflection-free fibre end t. The two gratings 1 and 2 reflect incoming light at their respective Bragg wavelengths, and a first portion P1 of this reflected signal is routed to a reference detector 4 by means of the first and second couplers C1 and C2. This first portion forms a reference signal S3. The reference detector 4 generates a signal which is indicative of the intensity of the reference signal, and communicates this to a processor 10.

A second portion P2 of the total reflected light from the gratings is routed to a demultiplexer 5, by means of the second coupler C2 and a length of fibre F. The demultiplexer 5 splits the incoming signal into a first signal S1 which comprises light which has been reflected by the first grating 1, and a second signal S2 which comprises light that has been reflected by the second FBG2. The demultiplexer achieves this by employing a filter element 51 which transmits wavelengths corresponding to the reflectance spectrum of the second grating 2, and reflects wavelengths corresponding to the reflectance spectrum of the first grating 1. The first signal S1 is then routed to a first edge filter 6 which covers a first detector 7. Thus the first detector 7 receives an edge filtered signal corresponding to light reflected by just the first grating 1. The second signal S2 is routed to a second edge filter 8, which covers a second detector 9. Similarly, the second detector 9 receives an edge filtered signal that has been reflected by the second grating 2. Outputs from the first and second detectors are fed to the processor 10. These outputs are indicative of the intensities of the filtered signals received by the first and second detectors. The processor calculates a ratio of the intensity signal from the first detector to the intensity signal from the reference detector. The processor also calculates a ratio of the intensity signal from the second detector to the intensity signal from the reference detector.

It will be appreciated that the total reflected signal from the series combination of gratings is split first by the coupler 2, and then by the demultiplexer 5, in forming the first and second signals S1 and S2. Furthermore, the total reflected signal is split first by the coupler C2 and then by the coupler C1 to produce the reference signal S3. By appropriate arrangement of the couplers and the demultiplexer, the first, second and reference signals can thus have similar intensities and this facilitates subsequent handling and processing.

The processor uses the calculated ratios to determine a temperature compensated value for the strain experienced by the first grating 1, using known techniques. Thus, the system is able to provide temperature compensated measurement of strain of the panel P using only three detectors 4, 7 and 9. In this example the design of the demultiplexer is based on GRIN lenses and an interference-filter, although other solutions are possible. The multiplexing of the two gratings on the same fibre enables these temperature compensated strain measurements to be made, whilst requiring only a relatively simple demultiplexing device. The system therefore represents a convenient apparatus for temperature compensated strain measurements, with a small component inventory.

Moving now to FIG. 4, this shows measurement apparatus embodying the present invention, in combination with a body B to be monitored. The apparatus includes a first fibre Bragg grating 1 embedded in the body B, and a second fibre Bragg grating 2 arranged in thermal proximity to the first grating, but inside a pocket 21. The pocket is filled with material having suitable properties such that strain experienced by the body B is not transmitted to the second FBG, i.e. strain of the body B does not affect the second FBG pitch. In this example the two fibre Bragg gratings have nominally the same Bragg wavelength, although in alternative embodiments the wavelength can be different. The two FBGs 1 and 2 are arranged in optical parallel, and are illuminated by a common light source 3, in the form of an SLED. Light from the source is conveyed to the parallel combination of gratings via first and second couplers C1 and C2, which are 50:50 couplers (also known as 3 dB or half power couplers). A portion P1 of the combined reflected signals on the first and second gratings is routed to a reference detector 4 via the second and then the first coupler. The reference detector 4 is a PIN diode.

The light signal transmitted by the first FBG1 is conveyed to a first edge filter 6 by means of a length of single mode optical fibre F1. Similarly, the transmitted signal from the second FBG is transmitted via a separate length of fibre, F2, to a second edge filter 8. The first and second edge filters are arranged to cover first and second PIN diodes 7, 9 respectively. Thus, the first and second PIN diodes 7 and 9 are used to detect the intensities of the filtered transmitted signals from the two gratings, and the reference PIN diode 4 detects the intensity of the combined reflected signal.

The light source 3, and the first, second and reference PIN diodes are contained in a control unit 12 which incorporates an LCI and a Thermo-Electric Cooler (TEC). The TEC keeps the detectors and the light source (SLED) at a constant operating temperature in order to reduce opto-electronic noise and to stabilise the frequency bandwidth of the SLED.

The control unit 12 also includes appropriate circuitry for comparing the detected filtered intensities with the detected reference intensity. The control unit processes these ratios in order to provide a temperature compensated measurement of the strain experienced by the first FBG.

The Digital Signal Processing (DSP) unit/circuitry is not located/mounted on the LCI/TEC unit, but outside it. Also, the DSP in the controller also can carry out other important signal conditioning processes such as averaging (to improve signal-to-noise ratio), Look-Up-Table or LUT operations (to compensate for non-linear sensor response), conversion of data into actual engineering units using a calibration factor (for each sensor), and conversion of digital signals into a serial output that is sent via RS-323 interface to mini PC. The calibration factors for each sensor/channel and the LUTs (if used) can be up-loaded to the controller via the serial port (from PC) before acquisition commences. The controller also automatically modulates (switches) the light sources.

In this example, the processor processes the signals from the three detectors in the following way. Firstly, it averages the signal from each detector, to remove random noise. Then, using the averaged values, it determines the ratio of the signal from the first detector to that from the reference detector. Next, it does the same for the second detector signal. Then, these ratios are compared with the LUT data, to linearise the results. Finally, the linearised values are multiplied by a calibration factor to convert them into a value (e.g. strain) for output/display to a user.

FIG. 5 shows a multi-channel sensor system embodying the present invention. This system comprises four sensor channels, a b c and d. Each sensor channel includes two fibre Bragg gratings, 1 and 2, having different Bragg wavelengths (i.e. wavelength multiplexed on the respective single channel). The FBG sensors of each channel are illuminated by a respective light source 3a, 3b, 3c and 3d. Respective second couplers C2a-d direct a portion of the total reflected signal from each channel to a respective demultiplexer 5a-d. A further portion of the total reflected signal from each channel is directed via the respective second coupler and a respective first coupler C1a-d to a common reference detector 4. Each demultiplexer device 5a-d splits the incoming signal into first and second signals S1 and S2, which contain wavelengths reflected by the first and second FBGs respectively. The first signals S1 from all four of the demultiplexer devices (i.e. from all of the sensor channels) are fed to a common first edge filter 6. This edge filter filters the incoming first signals, which are then detected by a first intensity detector 7. Similarly, the second signals S2 from all four channels are fed to a common second edge detector 8, before detection by a second common intensity detector 9. A controller 11 controls the operation of the light sources 3a-d. The controller can switch on the light sources in any desired sequence. When a single one of the light sources is on, the detectors 4, 7 and 9 detect the intensities of the signals from only the sensors of the corresponding channel. The detectors are connected to a processor 10 which calculates the ratios of the intensities of the filtered first and second signals S1 and S2 to the intensity of the reference signal S3 for each channel. The processor 10 and controller 11 form part of a control unit 12, which also includes the detectors and light sources.

FIG. 6 shows a further embodiment of the present invention. This is a sensor system incorporating two sensor channels, each one comprising a pair of nominally identical fibre Bragg gratings 1 and 2. The FBGs of the two channels are attached to the surface of a structure S whose strain is to be monitored. The sensors of the two channels are illuminated by respective light sources 3a, 3b, and the signals transmitted by the FBGs are transmitted via respective optical fibres to first and second intensity detectors, covered by first and second edge filters respectively. Light from the light sources 3a, 3b is conveyed to the FBGs by means of respective 50:50 couplers CA and CB. The same couplers are used to route a portion of the combined reflected light signal from each channel to a common reference detector 4.

Moving on to FIG. 7, this shows a highly schematic view of a fully integrated structural monitoring system based on optical fibre Bragg sensors, in accordance with a further embodiment of the present invention. Further details of the system of FIG. 7 are shown in FIG. 8. The system comprises a network of optical fibre sensors based on the Bragg grating sensing principle. In this particular example, the sensors are mainly used to sense temperature and displacement or strain, but in other embodiments other physical parameters may be monitored (for example tilt, humidity). The system represents a combination of parallel and multiplexed optical schemes, in that it employs two Bragg sensors 1, 2 in series on each fibre/channel. This enables easy and efficient compensation of, for example, temperature effects when measuring strain.

FIG. 7 shows the structural monitoring system mounted on a building 23. The system is powered by means of a solar panel unit 22 (including battery and recharging circuitry), connected to a control box 24. The control box 24 consists of a demodulation unit, as described above (which includes the DSP processing unit and serial interface etc.), plus a palm-top/mini-PC (e.g. Compaq iPAQ) which has an integrated (PC-card accessory) GSM modem and phone. In other embodiments the control box may include a number of demodulation units. In the present example, the control box 24 provides the light sources for the separate channels of fibre optic sensors, and receives the signals back from them. The control box 24 includes an integrated digital signal processor (DSP) for on-line signal processing (for example averaging, and LUT operations. The control box 24 also includes an RS-232 serial interface for digital output 14.

The embodiment shown comprises four independent measurement channels (each providing temperature compensated measurements of strain) but other embodiments can of course incorporate further channels.

The control box 24 includes an opto-electronics unit 13 which includes an independent light source (e.g. an SLED) for each channel. This arrangement improves the reliability of the system. One implementation of this system operates at the 1550 nm wavelength, and so is compatible with telecommunications wavelengths. An alternative system operates in the 750 nm to 850 nm wavelength range, using plastic optical fibre with Braggs. The control box 24 further comprises a GSM modem/phone integrated to allow e-mailing of data and/or messages back to a base station. In alternative embodiments, the system can be adapted to allow incoming commands via the GSM link (e.g. tone-dialed telephone call, SMS message or in-coming email). The solar panel 22 allows installation in remote sites (for example in sites where no electrical power is available, or sites where the provision of an electrical power supply is prohibited). The structural monitoring system is particularly advantageous for monitoring displacements and strains in buildings and structures forming part of cultural heritage sites. In such locations, the use of an electrical power supply is often prohibited because of the associated fire risks.

The control box 24 comprises a central controller in the form of a pocket-PC (i.e. a palm-top computer) running a Windows-CE operating system and a custom developed software package. The software package controls the data acquisition schedule, the processing of data, the logging of data, the basic interpretation of data which can be used for raising an alarm (for example if a significant amount of movement is detected in a structural member of a building), and the mini-PC can also optimise power consumption for example by regulating the power charging cycle from the solar panel/solar cell to the battery.

Returning to the embodiment shown in FIG. 5, although this embodiment shows a separate respective demultiplexing device 5 for each channel, in alternative embodiments, a single common demultiplexer can be used, arranged to receive the reflected signals from all channels.

It will be apparent that in the above described multi-channel sensor systems, some redundancy is built in, as one channel (and respective source) is used for each measurement. However, 2×multiplexing on each channel enables temperature compensated measurements to be made. This relatively simple 2×multiplexing enables a simple WDM demultiplexer device to be used.

Embodiments in which two gratings are series multiplexed on each channel combine the advantages of a parallel system (redundancy), and the advantages to be gained from multiplexing on a single fibre. In these arrangements, each channel may be addressed in series by appropriate control of the separate light sources. A simple WDM device can be used to separate the two wavelengths. In preferred embodiments, the wavelengths of the two FBGs can be 1535 and 1550 nm, for example, which are quite well separated. A simple cut-off filter can be used to separate these wavelengths, reflecting one and transmitting the other.

The edge filters for use in embodiments of the present invention may be custom made interference filters, comprising a plurality of dielectric layers. It is possible to have these filters custom designed to give the required characteristics (i.e. the required “slope”). These edge filter components are typically very expensive, and the embodiments of the present invention which take the form of multi-channel sensor systems using common edge filters are therefore particularly advantageous. The custom made interference filters may be formed on a glass substrate, which can then be bonded onto the appropriate sensor.

In choosing the characteristics of the edge filters, the following factors are taken into account. In general, the slope of the filter characteristics should be made broad enough so that one operates in the linear portion. However, for higher resolution, a bigger slope is desirable. In practice, the chosen characteristics of the filter represent a compromise.

In embodiments of the invention which use a DSP, a look-up table can be used in order to compensate for non-linear performance, and hence to provide accurate temperature compensation of measurements.

The use of a palm-top type controller in certain embodiments, in conjunction with the serial control of separate low power sources for each channel, enables the total power requirement of the system to be reduced to a level so that it can be met by a solar panel or cell. The fact that embodiments of the present invention can provide temperature compensated measurement of strain is particularly important, as thermal fluctuations can cause uncompensated measurements to vary by as much as 10 or 15%. The palm-top also supports ultra portability and is much cheaper that a lap-top solution.

For civil engineering applications, redundancy in measurement systems is an important requirement, and such systems typically use parallel channels. Edge filter techniques have in the past been criticised for not being compatible with multiplexing. Embodiments of the present invention incorporate advantages associated with the parallel and multiplexed techniques, and provide sufficient redundancy for civil requirements.

A particular embodiment is adapted for use in the roof space of a cathedral, for monitoring strain and displacement of structural components. In this location, there are no hard wire links, and an electricity supply is not permitted because of the fire risk. Thus, the system is powered by means of a solar panel in conjunction with a battery.

In this embodiment, relays are used to manage the power supply and power consumption of the unit. Systems which incorporate scanning to interrogate sensors are very power hungry, and the present embodiment requires a very much reduced amount of power because the sources can be operated separately. The opto-electronics are only powered up when measurements are required, and at other times the controlling micro processor is in sleep mode. When measurements are required, the relays are opened, the opto-electronics unit is powered up by the battery, and once the necessary components have reached stable operating temperature the measurements can be taken. Palm-top controllers have been found to be particularly advantageous for use in such embodiments as they typically incorporate sophisticated intelligent sleep mode features.

In cultural heritage sites, such as the cathedral roof space mentioned above, the systems embodying the present invention are particularly advantageous because they provide the usual advantages associated with optical fibre sensing techniques, they are minimally invasive, their operation is spark free, the sensors are corrosion resistant (often having to operate in damp conditions) and no intermediate amplifiers are required.

Advantageously, the control unit of the sensor system can monitor the measurements of temperature compensated strain taken by the sensors, and employ expert system type algorithms to detect significant events. In response to detection of these events, the controller can then raise an alarm in an appropriate way.

The edge filter techniques employed by embodiments of the present invention offers a convenient way of detecting wavelength shifts in the characteristics of Bragg gratings by looking at corresponding changes in the intensity of the filtered signal from the edge filter. The combination of using edge filter detection techniques and demodulation of signals from multiplexed gratings on a single fibre offers an ergonomic, simplified solution to the problem of providing a temperature compensated strain measurement system.

Turning now to FIG. 9, this shows a sensor system in accordance with a further embodiment. The system is similar to that shown in FIG. 3. Differences are that the first and second measurement signals S1 and S2 are signals transmitted by the series combination of first and second FBGs 1 and 2. These signals are multiplexed and are carried simultaneously by a single fibre to the demultiplexer 5. Thus, the transmitted signal T12 from the series combination of gratings is conveyed to the demultiplexer 5 where it is split into the first and second measurement signals. Each of these measurement signals occupies a respective bandwidth, and includes a notch corresponding to the reflectance characteristics of the respective grating. The gratings and edge filters 6 and 8 are selected such that the notch widths are significant compared with the bandwidths of the linear portions of the edge filter responses. This ensures that as the reflectance (and hence transmission) properties of the gratings shift with temperature or strain, the intensity of the signals reaching the first and second detectors 7 and 9 change by a substantial amount.

A further difference to the system shown in FIG. 3, is that the present system uses only a single coupler C1. This coupler is used to convey the light from the light source to the gratings, and also to route the reflected reference signals from the first and second gratings in combination to the reference detector 4.

FIG. 10 shows an alternative embodiment, similar to that shown in FIG. 4. In this embodiment, rather than using transmitted signals from the two gratings, their individual reflectance signals are separately routed to the first and second edge filters respectively by means of separate couplers C2 and C3. The same two couplers are used to route a portion of the total reflected signal from each grating to a further coupler C1. C1 in turn routes a portion of the total reflected signal to the reference detector 4. Light is supplied to both gratings by means of the first, second and third couplers. Although this arrangement uses more couplers than some other arrangements, advantageously, it requires no demultiplexer. The couplers are arranged such that each edge filter sees a measurement signal from only one of the gratings, and the reference detector receives a signal indicative of the combined reflected intensity.

Moving now to FIG. 11, this shows in highly schematic form a further embodiment of the present invention. In this embodiment a single coupler C1 is used to supply light to the two gratings arranged in parallel, and to route reflected reference signals from each grating to a common detector 4. In this example the first and second measurement signals are signals transmitted by the first and second gratings. These signals are combined by a second coupler C2 onto a single fibre. This fibre conveys the combined transmitted signal T12 to a demultiplexer 5. The demultiplexer 5 splits this combined transmitted signal into the first and second measurement signals from the two gratings.

FIG. 12 shows a further embodiment in which the two gratings 1 and 2 are arranged in parallel, and the first and second measurement signals are derived from a multiplexed reflected signal, by means of demultiplexer 5.

FIG. 13 shows a further embodiment, in which the reference detector 4 detects a combined reference signal which comprises a portion of the light transmitted by the first and second gratings in series. In this example the first and second measurement signals S1 and S2 are also transmitted signals from the two gratings, conveyed in multiplex fashion by a single length of fibre to a demultiplexer 5. Advantageously, by using transmitted signals as both the measurement signals and reference signals, the intensities detected by the first, second and reference detectors are approximately matched.

1. A sensor system comprising:
a first fibre Bragg grating (FBG);
a second FBG;
a light source arranged to provide light to the first and second FBGs, such that the first FBG outputs a first measurement signal, indicative of the reflectance spectrum of the first FBG, and a first reference signal, and the second FBG outputs a second measurement signal, indicative of the reflectance spectrum of the second FBG, and a second reference signal;
a first edge filter arranged to filter the first measurement signal;
a first detector arranged to detect an intensity of the filtered first measurement signal;
a second edge filter arranged to filter the second measurement signal;
a second detector arranged to detect an intensity of the filtered second measurement signal;
a reference detector arranged to detect a combined intensity of the first and second reference signals; and
a processor arranged to process signals from the first, second and reference detectors.

2. A sensor system in accordance with claim 1, wherein the first and second FBGs have different Bragg wavelengths, the system further comprising: a length of optical fibre arranged to convey the first and second measurement signals simultaneously; and a demultiplexer connected to the length of optical fibre and arranged to separate the first and second measurement signals and route them to the first and second edge filters respectively.

3. A sensor system in accordance with claim 2 wherein the first and second FBGs are arranged in series.

4. A sensor system in accordance with any preceding claim wherein the first and second measurement signals are signals reflected by the first and second FBGs respectively.

5. A sensor system in accordance with any one of claims 1 to 3 wherein the first and second measurement signals are signals transmitted by the first and second FBGs respectively.

6. A sensor system in accordance with any preceding claim wherein the first and second reference signals are signals reflected by the first and second FBGs respectively.

7. A sensor system in accordance with any preceding claim and comprising a plurality of measurement channels, each channel comprising a respective pair of said first and second FBGs and a respective said light source, wherein the first and second edge filters are arranged to filter the respective first and second measurement signals from all channels, and the reference detector is arranged to detect the respective combined intensities of the first and second reference signals from all channels, the system further comprising a controller arranged to control the light sources to selectively provide light to the FBGs of each channel, such that the first, second and reference detectors are used to interrogate the FBGs of all channels.

8. A sensor system comprising:
a first fibre Bragg grating having a first nominal Bragg wavelength;
a second fibre Bragg grating, arranged in series with the first, and having a second nominal Bragg wavelength;
a light source arranged to provide light to the series combination of first and second fibre Bragg gratings for reflection;
a reference detector arranged to detect an intensity of a reference signal comprising a first portion of the light reflected by the series combination of first and second fibre Bragg gratings;
a demultiplexer arranged to receive a second portion of the light reflected by the series combination of first and second fibre Bragg gratings and to split the second portion into a first signal, comprising light reflected by the first fibre Bragg grating, and a second signal, comprising light reflected by the second fibre Bragg grating;
a first edge filter arranged to filter the first signal;
a first detector arranged to detect the intensity of the filtered first signal,
a second edge filter arranged to filter the second signal;
a second detector arranged to detect the intensity of the filtered second signal; and
a processor, arranged to process signals from the first, second and reference detectors.

9. A sensor system in accordance with claim 8, wherein the light source is coupled to the series combination of first and second fibre Bragg gratings by first and second couplers connected in series with each other, the second coupler being proximate the fibre Bragg gratings, the demultiplexer is coupled to the second coupler, and the reference detector is coupled to the first coupler, such that the second portion is received by the demultiplexer via the second coupler, and the reference signal reaches the reference detector via the second coupler and then the first coupler.

10. A sensor system in accordance with claim 8 comprising first and second couplers, the second coupler being arranged to receive light reflected by the series combination of first and second FBGs and to route said second portion to the demultiplexer and a remaining portion to the first coupler, the first coupler being arranged to split said remaining portion into said first portion and a further remaining portion, and to route said first portion to the reference detector.

11. A sensor system in accordance with claim 10, wherein the light source is arranged to provide light to the series combination of FBGs via the first and second couplers.

12. A sensor system in accordance with any one of claims 9 to 11, wherein each of said couplers is a 50:50 coupler.

13. A sensor system in accordance with any one of claims 8 to 12, further comprising a reflection-suppressing termination arranged to suppress reflection of light transmitted by the FBGs back to the demultiplexer and reference detector.

14. A sensor system in accordance with any one of claims 8 to 13 wherein the demultiplexer comprises a filter arranged to reflect light reflected by one of the first and second FBGs and transmit light reflected by the other FBG.

15. A sensor system in accordance with claim 14, wherein the demultiplexer comprises a GRIN lens.

16. A sensor system in accordance with any one of claims 8 to 15, and comprising a plurality of sensor channels, each sensor channel comprising: a series combination of respective said first and second FBGs; a respective said light source; and a respective said demultiplexer,
the system further comprising a controller arranged to control the light sources to selectively illuminate the series combinations of FBGs of each channel,
wherein the reference detector is a common detector arranged to detect the intensity of the reference signal from each channel, the first edge filter is a common filter arranged to filter the first signal from each channel, the first detector is a common detector arranged to detect the intensity of the filtered first signal from each channel, the second edge filter is a common filter arranged to filter the second signal from each channel, the second detector is a common detector arranged to detect the intensity of the filtered second signal from each channel,
and said processor is a common processor arranged to process respective signals from the first, second and reference detectors for each channel.

17. A sensor system comprising:
a first fibre Bragg grating;
a second fibre Bragg grating, arranged in parallel with the first;
a light source arranged to provide light to the parallel combination of first and second fibre Bragg gratings for reflection;
a reference detector arranged to detect an intensity of a reference signal comprising at least a portion of the light reflected by the parallel combination of first and second fibre Bragg gratings;
a first edge filter arranged to filter a first signal comprising light transmitted by the first fibre Bragg grating;
a first detector arranged to detect the intensity of the filtered first signal;
a second edge filter arranged to filter a second signal comprising light transmitted by the second fibre Bragg grating;
a second detector arrange to detect the intensity of the filtered second signal;
and a processor arranged to process signals from the first, second and reference detectors.

18. A sensor system in accordance with claim 17, wherein the light source and reference detector are coupled to the first and second FBGs by a single, common coupler.

19. A sensor system in accordance with claim 17 or claim 18, comprising a first optical fibre connecting the first FBG to the first edge filter, to convey the light transmitted by the first FBG, and a second optical fibre connecting the second FBG to the second edge filter, to convey the light transmitted by the second FBG.

20. A sensor system in accordance with any one of claims 17 to 19, the system comprising a plurality of sensor channels, each sensor channel comprising: a parallel combination of respective said first and second FBGs; and a respective said light source, the system further comprising a controller arranged to control the light sources to selectively illuminate the parallel combinations of FBGs of each channel, wherein the reference detector is a common detector arranged to detect the intensity of the reference signal from each channel, the first edge filter is a common filter arranged to filter the first signal from each channel, the first detector is a common detector arranged to detect the intensity of the filtered first signal from each channel, the second edge filter is a common filter arranged to filter the second signal from each channel, the second detector is a common detector arranged to detect the intensity of the filtered second signal from each channel,
and said processor is a common processor arranged to process respective signals from the first, second and reference detectors for each channel.

21. A sensor system in accordance with claim 16 or claim 20, comprising four sensor channels.

22. Strain measurement apparatus comprising a sensor system in accordance with any preceding claim, the first FBG being adapted for mechanical coupling to an object, body or structure whose strain is to be monitored, the second FBG being adapted for location in the same thermal environment as the first FBG in a manner such that it is decoupled from the strain to be monitored, the processor being arranged to determine a temperature-compensated value of the strain experienced by the first FBG from said signals from the first, second and reference detectors.

23. Strain measurement apparatus in accordance with claim 22, in combination with an object, body or structure to be monitored, wherein the first FBG is mechanically coupled to the object, body or structure such that a strain of the object, body or structure is communicated to the first FBG, and the second FBG is arranged in substantially the same thermal environment as the first FBG, the second FBG being further arranged so as to be decoupled from said strain.

24. Strain measurement apparatus in accordance with claim 22 for use in remote locations such as on bridges, dams and relatively inaccessible parts of buildings, the apparatus comprising an opto-electronics unit including the processor and light source or sources, and a solar panel and/or battery for powering the opto-electronics unit.

25. Strain measurement apparatus in accordance with claim 24, further comprising a GSM modem to communicate measured strain values to a remote location.

26. A measurement method comprising the steps of:
arranging a sensor system in accordance with any one of claims 1 to 21;
arranging the first FBG to sense a parameter to be measured;
arranging the second FBG in substantially the same thermal environment as the first FBG and in a manner such that the second FBG is substantially insensitive to said parameter;
and determining a temperature-compensated value of said parameter from the signals from the first, second and reference detectors.

27. A measurement method in accordance with claim 26, wherein said step of arranging the first FBG comprises mechanically coupling the first FBG to an object, body or structure to sense strain.
